(19) United States
(12) Patent Application Publication
(10) Pub. No.: US 2017/0226393 A1
(43) Pub. Date: Aug. 10, 2017

(54) GLUE COMPOSITION

(71) Applicant: UHU GmbH & Co. KG, Bühl (DE)

(72) Inventor: Aurelia Liar, Achern (DE)

(21) Appl. No.: 15/500,275

(22) PCT Filed: Jul. 28, 2015
(86) PCT No.: PCT/DE2015/100318

§ 371 Date: Jan. 30, 2017

(30) Foreign Application Priority Data
Jul. 30, 2014 (DE) 10 2014 110 794.2

(51) Int. Cl. C09J 199/00; C08K 5/09; C09J 103/02

(52) U.S. Cl. CPC C09J 199/00; C09J 103/02; C08K 5/09

(57) ABSTRACT

The invention relates to a glue composition which has a proportion of water, starch and/or starch derivatives, glycerin and at least one fatty acid and/or a salt of a fatty acid of at least 98% by weight.

The invention relates to a glue composition as well as a glue stick which contains a glue composition according to the invention.

Glue sticks have been known for a long time and are used in particular for gluing paper, cardboard, pictures and other common materials. The known glue sticks usually contain aqueous preparations of an adhesively acting substance, such as polyvinylpyrrolidone, aqueous polyacrylates, polyvinyl alcohols, and blends in conjunction with structure-forming ingredients, such as fatty acids, which, in the form of a soap gel, provide the glue stick with the consistency which allows it to hold its shape. Starch-based glue sticks are also known, their adhesively acting substance being primarily starch. Propylene glycol is often added to the glue sticks as a softening agent.

The object of this invention is to provide a glue composition or rather a glue stick which on the hand has excellent gluing qualities and on the other hand has as little negative impact on the environment and on health as possible.

This problem is solved by a glue composition which is characterized by containing a proportion of water, starch and/or starch derivatives, glycerin and at least one fatty acid and/or a salt of a fatty acid of at least 98% by weight.

Surprisingly, it has proven that a glue composition having a proportion of at least 98% by weight water, starch and/or starch derivatives, glycerin and fatty acid or fatty acid salt, respectively, has excellent adhesive qualities. Simultaneously, these components are natural components which are nonhazardous from an ecological perspective. Moreover, the components water, starch, glycerin and fatty acids are mostly food, which are all entirely harmless for the human body. As a rule, glycerin of plant origin is used.

A particularly preferred embodiment of the glue composition according to the invention is essentially free of organic solvents, in particular free of solvents having a boiling point beneath 200° C. It has proven that such solvents can be entirely dispensed with in the glue composition according to the invention. In contrast thereto, the glue compositions from the known state of the art generally comprise at least small amounts of such solvents. Such solvents are generally harmful for the environment and human health. Moreover, such solvents often have an unpleasant and strong smell.

Advantageously, the glue composition according to the invention is free of polyvinylpyrrolidon, propylene glycol and caprolactam. These compounds are partly found in many glue compositions and have a negative effect on the environment or health.

A preferred embodiment of the glue composition according to the invention contains water at a proportion of 40-70% by weight, starch and/or starch derivatives at a proportion of 10-40% by weight, glycerin at a proportion of 1-20% by weight and fatty acid and/or salt of a fatty acid at a proportion of 2-20% by weight. A particularly advantageous embodiment of the glue composition according to the invention contains water at a proportion of 55-65% by weight, in particular 60% by weight, starch and/or starch derivatives at a proportion of 20-25% by weight, in particular 23% by weight, glycerin at a proportion of 5-15% by weight, in particular 10% by weight, and fatty acid and/or salt of a fatty acid at a proportion of 2-8% by weight, in particular 5% by weight. The proportional ratios of water, starch, glycerin and fatty acid mentioned above have particularly advantageous features, in particular regarding the adhesive qualities.

Preferably, the glue composition according to the invention contains potato or corn starch as starch. These types of starch are particularly advantageous regarding the environment and health and, moreover, are inexpensive raw materials.

Of the starches produced in the EU, 40 to 50% are used for industrial purposes (the bulk of which is used in producing paper and corrugated cardboard). A controlled cultivation on specifically designated cropland is ensured. Moreover, a consistent quality of the plant is guaranteed and not a genetic modification. By cultivating and purchasing the plants within Europe, environmental requirements and social competences are guaranteed at all times. Moreover, transport time is very short in comparison to that of other types of starch, such as rice, tapioca or manioc, which is another positive factor. Starch as a renewable raw material is sustainable and ecological as well as particularly advantageous from an economical perspective in comparison to raw materials based on mineral oil, such as polyvinylpyrrolidone.

The glue composition according to the invention can also contain dextrin and/or starch-based sugars. Moreover, the glue composition can contain small amounts of other additives, such as whitening agents, bleaching agents and filling agents.

Advantageously, the at least one fatty acid is a C₁₄ or C₁₆ fatty acid. These fatty acids exhibit particularly advantageous features in the glue composition according to the invention, in particular regarding forming structures and adhesive qualities.

The at least one fatty acid of the glue composition according to the invention is preferably derived on a plant basis, in particular from canola oil, sunflower seed oil, linseed oil, mustard oil, olive oil, peanut oil, palm oil, palm kernel oil, grape seed oil, pumpkin seed oil, soybean oil, coconut oil, avocado oil, almond oil, safflower seed oil, canola oil and/or thyme oil. All of these oils are nonhazardous for the environment.

Besides their structure-forming function, the oils/fatty acids mentioned above can also fulfill functions as a softening agent in conjunction with glycerin.

Advantageously, the glue composition according to the invention contains at least one of the group of perfume oils, in particular perfume oils made of blossoms, fruit, timbers and/or spices, natural dyes, in particular plant-derived natural dyes, and natural preservatives, in particular ascorbic acid and/or essential oils. All of these oils are natural compounds which are entirely nonhazardous for the environment.

A further preferred embodiment of the glue composition according to the invention contains at least one pH indicator, preferably with a proportion of less than 0.1% by weight. This indicator preferably comprises a transition range between pH 7 and 9. An example of such a pH indicator is thymolphthalein. Glue compositions having such a pH indicator show the pH value of the glue composition in a simple manner via a particular color. The practical advantage of such pH indicators is, for example, that the color of the glue composition (for example blue for thymolphthalein) allows visually perceiving where the glue composition has been applied, for example whether glue has been applied in corner areas. Additionally, children can learn how to properly apply glue through play. Moreover, applying glue is made easier for people suffering from visual impairments. The advantage of these pH indicators, for example thymolphthalein, also consists of the fact that the color disappears via a reaction with CO₂ in the air a few seconds after the glue has been applied.

A preferred embodiment of the glue composition according to the invention is characterized in that the proportion of non-evaporable components consists of nearly 100% natural ingredients, in particular starch and/or starch derivatives, fatty acid and/or fatty acid salt and glycerin. Regarding the entire glue composition, this proportion is approximately 40% by weight. Such glue compositions have particularly advantageous features (c.f. comparative tests).

The invention at hand further relates to a glue stick, containing a glue composition according to the invention.

A glue composition according to the invention can be produced as follows: heated water is provided and preserved if necessary; after, glycerin is stirred in; after having stirred in the glycerin, starch is added from a storage tank beneath the liquid level by means of a vacuum; following this, the fatty acid is also added from a storage tank beneath the liquid level by means of a vacuum; at a temperature of approximately 70° C., the mixture is alkalified; the mixture is stirred for several minutes under vacuum; if necessary, auxiliary agents, for example perfume, are stirred in at the end; the end temperature is about 75-85° C.; after having cooled, the thus produced glue composition solidifies.

Comparative Tests:

A glue composition from the state of the art (comparative composition) is compared having the following composition:

57% by weight water, 23% by weight polyvinylpyrrolidone, 14% by weight glycerin, 5% by weight structure formers and 1% by weight sodium hydroxide.

As a comparison, a glue composition according to the invention is tested having the following composition:

60% by weight water, 23% by weight starch, 10% by weight glycerin, 5% by weight fatty acid and 1% by weight sodium hydroxide.

The following tests were conducted:

1. Determining the Penetration of Glue Sticks

Test Description:

It is determined how deep a steel pin penetrates the glue. The glue stick is kept at a temperature of 20° C./65% RH for 24 hours. The penetrometer is set for a defined penetration time. The glue stick is twisted out of the tube and placed in the device. The detector is contacted with the sample. The steel pin is lowered so that its tip touches the surface of the sample. Then the drop bar is triggered. After each measurement, the drop bar is returned to its starting position and the reading is reset to 0.

Evaluation:

Each glue stick is tested six times and the average value is given in mm.

| | | comparative | formula according |
|---|---|---|---|
| | | composition | to the invention |
| example: | [mm] | 2.2 | 2.6 |

2. Transferring Glue Sticks Using a Mechanical Testing Device

The weight of loss is determined which results when the glue is mechanically applied to a roll of paper having a defined length under constant pressure.

The test is conducted under constant test conditions. The glue stick is conditioned at 20° C./65% RH for 24 hours. The roll of paper is inserted into the testing device. Approximately 0.5 cm of the glue stick is twisted out and cut off using a knife. This ensures that the glue stick has a smooth surface and lies on the paper with its entire surface. Before the test, the glue stick is weighed. After the weighing, the glue stick is mounted into the device of the driving cart and another defined length of the glue is twisted out of the tube. The corresponding testing program is chosen and the test started. Guided by a linear axis, the glue stick is moved over the roll of paper along a defined path at a constant speed and constant weight load. The path length is 1 m, for example. The glue stick is carefully taken out of the device and reweighed.

Evaluation:

The process is repeated a total of 5 times. All five results are used to make up an average value. The result is shown in mg/m.

If clumps of glue form at the edge of the tube while being measured, they will be considered as follows: the glue particles formed at the edge of the tube are carefully removed after the glue stick has been reweighed and the glue stick is then weighed again.

| | | comparative | formula according |
|---|---|---|---|
| | | composition | to the invention |
| example: | [mg/m] | 80-90 | 100 |

3. Manual Paper Adhesion Value with Glue Sticks

Test Procedure:

The time span is determined between applying the glue and the paper tearing. Approximately 0.5 cm of the glue is twisted out of the tube and cut off using a knife so as to receive a smooth surface. On a defined testing strip, glue is applied from left to right once and/or thrice and a second testing strip is congruently pressed onto the first testing strip using finger pressure. A stop watch is immediately actuated. Now, the testing strips are steadily pulled apart until the papers tear and the time is determined.

Evaluation:

The test is repeated four times and the average value [sec] is evaluated.

| | | | comparative | formula according |
|---|---|---|---|---|
| | | | composition | to the invention |
| example: | [sec] | 1x | 35 | 20 |
| | | 3x | 30 | 15 |

4. Testing the Peel Strength and Tensile Strength of Glue Sticks

Peel Strength:

Test Description:

The peel strength of glue sticks is tested when gluing paper to paper (for example toilet paper). A paper strip (defined quality) is fixated. The mechanical testing device serves for removing glue in a defined manner. The driving cart stopper is set for a defined length.

Approximately 0.5 cm of the glue is twisted out of the tube and cut off using a knife. This ensures that the glue stick has a smooth surface and lies on the paper with its entire surface. Before the test, the glue stick, which was kept at the same temperature for 24 hours, is weighed, mounted into the driving cart and is twisted out of the tube for a defined length. The glue to be tested is applied for a defined length by means of the testing device under defined conditions. The glue stick is carefully removed from the device and reweighed. After having been reweighed, a second paper strip (defined quality) is congruently and lightly pressed onto the first paper strip using finger pressure and then immediately pressed together for a defined time at a defined pressure. Subsequently, the peel strength is measured using the tensile testing machine. The average peel strength of the glue is evaluated at a constant testing speed.

Evaluation:

The process is repeated four times or nine times, respectively, and the average value of the force [N/mm] realized during the peel test is evaluated.

| | comparative | formula according |
|---|---|---|
| | composition | to the invention |
| example: [N/mm], 1x application | 0.041 | 0.046 + all paper tears |

The new formula is significantly stronger in comparison to the commonly available formula based on PVP and starch.

Tensile Strength:

Test Description:

The tensile strength of glue sticks is tested when gluing paper to paper (for example construction paper 300 mg/m²).

The glue is applied on a defined surface with a defined amount of glue and is congruently glued to a second testing strip. After approximately 30 seconds, the tensile strength is measured using the tensile testing machine. At a constant testing speed, the average tensile strength is determined.

Evaluation:

The measurements are repeated several times. The average value of the force realized during the tensile tests is read from the test log in N/mm² after the test has been terminated.

| | comparative | formula according |
|---|---|---|
| | composition | to the invention |
| example: [N/mm²], 1x application | 0.38 | 0.564 + all paper tears |

The new formula is significantly stronger in comparison to the commonly available products based on PVP and starch.

5. Manual Long-Term Adhesions with Glue Sticks

Test Procedure:

The glue performance is determined on different qualities of paper after defined times under different storage conditions (c.f. table below).

Approximately 0.5 cm of glue is twisted out of the tube and cut off using a knife in order to receive a smooth surface. On a testing strip, glue is applied in the center once to thrice from left to right and a second testing strip is congruently pressed onto the first testing strip using finger pressure. For each quality of paper, storage condition and storage time, five adhesions are provided.

Evaluation:

The samples are torn after one week, one month, three and six months. The tear image including the glue strength of the glued materials is assessed.

| | Storage | | | | | |
|---|---|---|---|---|---|---|
| Material | temp. | Application | 1 week | 1 month | 3 months | 6 months |
| | | | Comparative composition based on PVP | | | |
| | | | (c.f. pg. 4) | | | |
| | | | (solid content: approx. 37%) | | | |
| Copy paper | RT | 1x | 3 | 3 | 3 | 3 |
| | | 3x | 1 | 1 | 2 | 2 |
| | 40° C. | 1x | 3 | 3 | 3 | 4 |
| | | 3x | 1 | 1 | 2 | 2 |
| | Climate | 1x | 3 | 3 | 4 | 4 |
| | 40° C./75% | 3x | 1 | 1 | 3 | 3 |
| Graph paper | RT | 1x | 2 | 2 | 4 | 4 |
| | | 3x | 1 | 1 | 3 | 3 |
| | 40° C. | 1x | 2 | 2 | 4 | 4 |
| | | 3x | 1 | 1 | 1 | 1 |
| | Climate | 1x | 3 | 3 | 3 | 3 |
| | 40° C./75% | 3x | 2 | 2 | 2 | 2 |
| Handicraft | RT | 1x | 4 | 4 | 4 | 4 |
| paper | | 3x | 2 | 2 | 2 | 2 |
| | 40° C. | 1x | 2 | 2 | 4 | 4 |
| | | 3x | 3 | 3 | 3 | 3 |
| | Climate | 1x | 5 | 5 | 5 | 5 |
| | 40° C./75% | 3x | 4 | 4 | 4 | 4 |
| | | | Formula according to the invention (pg. 49) | | | |
| | | | (solid content: approx. 40%) | | | |
| Copy paper | RT | 1x | 1 | 1 | 2 | 2 |
| | | 3x | 1 | 1 | 1 | 1 |
| | 40° C. | 1x | 1 | 1 | 1 | 1 |
| | | 3x | 1 | 1 | 1 | 1 |
| | Climate | 1x | 1 | 2 | 2 | 2 |
| | 40° C./75% | 3x | 1 | 1 | 1 | 1 |
| Graph paper | RT | 1x | 1 | 1 | 1 | 1 |
| | | 3x | 1 | 1 | 1 | 1 |
| | 40° C. | 1x | 1 | 1 | 1 | 1 |
| | | 3x | 1 | 1 | 1 | 1 |
| | Climate | 1x | 2 | 2 | 2 | 2 |
| | 40° C./75% | 3x | 1 | 1 | 1 | 1 |
| Handicraft | RT | 1x | 1 | 1 | 2 | 2 |
| paper | | 3x | 1 | 1 | 1 | 1 |
| | 40° C. | 1x | 1 | 1 | 1 | 1 |
| | | 3x | 1 | 1 | 1 | 1 |
| | Climate | 1x | 1 | 1 | 2 | 2 |
| | 40° C./75% | 3x | 1 | 1 | 1 | 1 |
| Photo in | RT | 1x | 1 | 1 | | |
| photo album | | 3x | 1 | 1 | | |
| | 40° C. | 1x | 1 | 1 | | |
| | | 3x | 1 | 1 | | |
| | Climate | 1x | 1 | 1 | | |
| | 40° C./75% | 3x | 1 | 1 | | |

| | | | Comparative product based on starch* | | | |
|---|---|---|---|---|---|---|
| | Storage | | (solid content: approx. 50%) | | | |
| Material | temp. | Application | 1 week | 1 month | 3 months | 6 months |
| Copy paper | RT | 1x | 1 | 1 | 2 | 2 |
| | | 3x | 1 | 1 | 1 | 1 |
| | 40° C. | 1x | 1 | 1 | 2 | 2 |
| | | 3x | 1 | 1 | 1 | 1 |
| | Climate | 1x | 1 | 1 | 5 | 5 |
| | 40° C./75% | 3x | 1 | 1 | 5 | 5 |
| Graph paper | RT | 1x | 1 | 1 | 3 | 5 |
| | | 3x | 1 | 1 | 1 | 5 |
| | 40° C. | 1x | 1 | 1 | 3 | 3 |
| | | 3x | 1 | 1 | 1 | 1 |
| | Climate | 1x | 1 | 1 | 5 | 5 |
| | 40° C./75% | 3x | 1 | 1 | 5 | 5 |
| Handicraft | RT | 1x | 1 | 1 | 2 | 2 |
| paper | | 3x | 1 | 1 | 1 | 1 |
| | 40° C. | 1x | 1 | 1 | 1 | 1 |
| | | 3x | 1 | 1 | 1 | 1 |
| | Climate | 1x | 1 | 3 | 5 | 5 |
| | 40° C./75% | 3x | 1 | 3 | 5 | 5 |
| Photo in | RT | 1x | 2 | 2 | | |
| photo album | | 3x | 1 | 1 | | |
| | 40° C. | 1x | 2 | 3 | | |
| | | 3x | 2 | 1 | | |
| | Climate | 1x | 2 | 2 | | |
| | 40° C./75% | 3x | 1 | 1 | | |

*The proportion of starch, glycerin, water and fatty acid is only 90% by weight.

| | | | Vergleichsprodukt 2 auf PVP-Basis | | | |
|---|---|---|---|---|---|---|
| | Storage | | (Festkörpergehalt: ca. 30%) | | | |
| Material | temp. | Application | 1 week | 1 month | 3 months | 6 months |
| Copy paper | RT | 1x | 4 | 4 | 5 | 5 |
| | | 3x | 4 | 4 | 5 | 5 |
| | 40° C. | 1x | 5 | 5 | 5 | 5 |
| | | 3x | 3 | 3 | 3 | 4 |
| | Climate | 1x | 4 | 4 | 5 | 5 |
| | 40° C./75% | 3x | 2 | 2 | 3 | 5 |
| Graph paper | RT | 1x | 5 | 5 | 5 | 5 |
| | | 3x | 3 | 3 | 4 | 4 |
| | 40° C. | 1x | 5 | 5 | 5 | 5 |
| | | 3x | 3 | 3 | 5 | 5 |
| | Climate | 1x | 3 | 3 | 5 | 5 |
| | 40° C./75% | 3x | 1 | 1 | 3 | 5 |
| Handicraft | RT | 1x | 4 | 4 | 5 | 5 |
| paper | | 3x | 2 | 2 | 3 | 4 |
| | 40° C. | 1x | 5 | 4 | 4 | 5 |
| | | 3x | 3 | 3 | 3 | 3 |
| | Climate | 1x | 4 | 5 | 5 | 5 |
| | 40° C./75% | 3x | 2 | 2 | 5 | 5 |
| Foto in | RT | 1x | 4 | 5 | | |
| Fotoalbum | | 3x | 2 | 2 | | |
| | 40° C. | 1x | 4 | 5 | | |
| | | 3x | 3 | 3 | | |
| | Climate | 1x | 5 | 5 | | |
| | 40° C./75% | 3x | 2 | 2 | | |

| | | | Vergleichsprodukt 3 auf PVP-Basis | | | |
|---|---|---|---|---|---|---|
| | Storage | Appli- | (Festkörpergehalt: ca. 50%) | | | |
| Material | temp. | cation | 1 Wo. | 1 Mo. | 3 Mo. | 6 Mo. |
| Copy | RT | 1x | 1 | 1 | 3 | 4 |
| paper | | 3x | 1 | 1 | 1 | 2 |
| | 40° C. | 1x | 1 | 1 | 4 | 5 |
| | | 3x | 1 | 1 | 1 | 1 |
| | Climate | 1x | 4 | 5 | 5 | 5 |
| | 40° C./75% | 3x | 3 | 5 | 5 | 5 |
| Graph | RT | 1x | 5 | 5 | 5 | 5 |
| paper | | 3x | 1 | 3 | 3 | 5 |
| | 40° C. | 1x | 5 | 5 | 5 | 5 |
| | | 3x | 2 | 2 | 2 | 3 |
| | Climate | 1x | 5 | 5 | 5 | 5 |
| | 40° C./75% | 3x | 5 | 5 | 5 | 5 |
| Handicraft | RT | 1x | 3 | 1 | 5 | 5 |
| paper | | 3x | 1 | 1 | 5 | 5 |
| | 40° C. | 1x | 4 | 4 | 4 | 5 |
| | | 3x | 3 | 3 | 3 | 3 |
| | Climate | 1x | 5 | 5 | 5 | 5 |
| | 40° C./75% | 3x | 5 | 5 | 5 | 5 |

| | | | Vergleichsprodukt 4 auf PVP-Basis | | | |
|---|---|---|---|---|---|---|
| | Storage | Appli- | (Festkörpergehalt: ca. 35%) | | | |
| Material | temp. | cation | 1 Wo. | 1 Mo. | 3 Mo. | 6 Mo. |
| Copy | RT | 1x | 3 | 3 | 5 | 5 |
| paper | | 3x | 2 | 2 | 3 | 3 |
| | 40° C. | 1x | 3 | 3 | 4 | 4 |
| | | 3x | 1 | 2 | 2 | 2 |
| | Climate | 1x | 2 | 3 | 5 | 5 |
| | 40° C./75% | 3x | 1 | 1 | 2 | 2 |
| Graph | RT | 1x | 3 | 3 | 4 | 5 |
| paper | | 3x | 1 | 3 | 4 | 4 |
| | 40° C. | 1x | 4 | 4 | 5 | 5 |
| | | 3x | 1 | 1 | 2 | 2 |
| | Climate | 1x | 1 | 2 | 3 | 3 |
| | 40° C./75% | 3x | 1 | 1 | 1 | 1 |
| Handicraft | RT | 1x | 4 | 4 | 5 | 5 |
| paper | | 3x | 1 | 1 | 3 | 3 |
| | 40° C. | 1x | 4 | 4 | 4 | 4 |
| | | 3x | 2 | 2 | 2 | 2 |
| | Climate | 1x | 3 | 5 | 5 | 5 |
| | 40° C./75% | 3x | 2 | 2 | 2 | 2 |

1 Paper tear

2 Fiber tear to paper tear

3 Partial fiber tear to paper tear to adhesion

4 Adhesion and partial fiber tear to paper tear

5 Adhesion to falls apart upon touch

6 No adhesion—already fallen apart

As in particular a comparison of the formula according to the invention to the starch-based comparative product shows, the formula according to the invention having a content of water, starch, glycerin and fatty acid of 98% by weight has better features than the comparative product whose content is only 90% by weight.

In total, it can be said that the glue composition according to the invention glues stronger and faster, exhibits a perfect sliding behavior on paper and is enduring and utterly efficient. Moreover, the glue composition according to the invention is preferably completely free of solvents and free of critical ingredients. Moreover, the glue composition according to the invention is user friendly since it is easy for consumers to use, clean, can be applied evenly, rarely forms any clumps and shows a very good and pleasant sliding behavior. The glue composition according to the invention is based on natural ingredients and has excellent product qualities and sustainability.

1. A glue composition, characterized in that the glue composition has a proportion of water, starch and/or starch derivatives, glycerin and at least one fatty acid and/or at least one salt of a fatty acid of at least 98% by weight.

2. The glue composition according to claim 1, characterized in that the glue composition is essentially free of organic solvents, in particular free of solvents having a boiling point beneath 200° C.

3. The glue composition according to claim 1, characterized in that the glue composition is free of polyvinylpyrrolidone, propylene glycol and caprolactam.

4. The glue composition according to claim 1, characterized in that the glue composition contains water at a proportion of 40-70% by weight, starch and/or starch derivatives at a proportion of 10-40% by weight, glycerin at a proportion of 1-20% by weight and fatty acid and/or salt of a fatty acid at a proportion of 2-20% by weight.

5. The glue composition according to claim 1, characterized in that the glue composition contains water at a proportion of 55-65% by weight, in particular 60% by weight, starch and/or starch derivatives at a proportion of 20-25% by weight, in particular 23% by weight, glycerin at a proportion of 5-15% by weight, in particular 10% by weight, and fatty acid and/or salt of a fatty acid at a proportion of 2-8% by weight, in particular 5% by weight.

6. The glue composition according to claim 1, characterized in that the glue composition contains potato starch and/or corn starch as starch.

7. The glue composition according to claim 1, characterized in that the glue composition contains dextrin and/or starch-based sugars.

8. The glue composition according to claim 1, characterized in that the at least one fatty acid is a C₁₄ or C₁₆ fatty acid.

9. The glue composition according to claim 1, characterized in that the at least one fatty acid is derived on a plant basis, in particular from canola oil, sunflower seed oil, linseed oil, mustard oil, olive oil, peanut oil, palm oil, palm kernel oil, grape seed oil, pumpkin seed oil, soybean oil, coconut oil, avocado oil, almond oil, safflower seed oil, castor oil and/or thyme oil.

10. The glue composition according to claim 1, characterized in that the glue composition contains at least one of the group of perfume oils, in particular perfume oils derived from blossoms, fruit, timbers and/or spices, natural dyes, in particular plant-derived natural dyes, and natural preservatives, in particular ascorbic acid and/or essential oils.

11. The glue composition according to claim 1, characterized in that the glue composition contains at least one pH indicator, in particular a pH indicator having a transition range from pH 7 to 9, preferably having a proportion of less than 0.1% by weight.

12. The glue composition according to claim 1, characterized in that the proportion of non-evaporable components, in particular the proportion of starch and/or starch derivatives, fatty acid and/or fatty acid salt and glycerin is approximately 40% by weight.

13. A glue stick, containing a glue composition according to claim 1.
